(19) United States
(12) Patent Application Publication
(10) Pub. No.: US 2026/0358501 A1
(43) Pub. Date: Nov. 12, 2026

(54) METHOD AND DEVICE FOR REMOVING A GHOST OBJECT

(71) Applicants: HYUNDAI MOTOR COMPANY, Seoul (KR); KIA CORPORATION, Seoul (KR)

(72) Inventors: Yo Han SUNG, Hwaseong-si (KR); Jae Won KEY, Hwaseong-si (KR)

(21) Appl. No.: 19/662,858

(22) Filed: Apr. 29, 2026

(30) Foreign Application Priority Data
May 7, 2025 (KR) 10-2025-0058897

(51) Int. Cl. G01S 17/89; B60W 60/00; G01S 17/931

(52) U.S. Cl. CPC G01S 17/89; B60W 60/001; G01S 17/931; B60W 2420/408

(57) ABSTRACT

Disclosed herein a method and device for removing a ghost object. The method includes generating allowable point distribution data based on an allowable point distribution estimated from a point distribution assignable to an object associated with a boundary region based on LiDAR sensor data; determining whether the object in the boundary region is a ghost object based on the allowable point distribution data and actual point distribution data of the boundary region; and removing the object determined to be the ghost object.

### CROSS-REFERENCE TO RELATED APPLICATION

This application claims the benefit of priority to Korean Patent Application No. 10-2025-0058897, filed in the Korean Intellectual Property Office on May 7, 2025, the disclosure of which is incorporated herein by reference in its entirety.

### Technical Field

The present disclosure relates to a method and device for removing ghost objects, and to a method and device for removing ghost objects that improve the performance of object detection by removing ghost objects caused by the unique characteristics of a sensor.

### Background

The matters described in this Background section are only for enhancement of understanding of the background of the disclosure, and should not be taken as acknowledgment that they correspond to prior art already known to those skilled in the art.

Autonomous driving functions may be used so that vehicles may control their own driving while minimizing or completely excluding driver intervention, and technologies supporting the autonomous driving functions may be applied to vehicles.

To implement autonomous driving, a vehicle collects surrounding environment information through various sensors. Based on data obtained from these sensors, the vehicle may recognize the surrounding environment and utilize the recognized information to identify a situation around the vehicle. A control plan for autonomous driving is established according to the identified situation, such that autonomous driving may be executed by controlling a driving device of the vehicle.

Autonomous driving utilizes various sensors for a vehicle to accurately recognize a surrounding environment. Autonomous driving may use a learning model for recognizing an object detected from the sensor. The sensor may include, for example, a camera, a LiDAR sensor, and a radar sensor. The learning model may detect an object from sensor data, for example, and provide a region surrounding the object, a type (or class) of the object surrounded by the region, a position of the object, and the like as output data in order to identify the detected object. In addition, the learning model may be trained using ground truth data of the same type as the output data.

The LiDAR sensor may recognize an object in three dimensions, and the learning model may generate, for example, a region and a position in three dimensions. When the learning model is constructed by data of the LiDAR sensor, the learning model may be trained by using ground truth data including a region, a three-dimensional position, a class, and the like that are expressed in three dimensions.

The LiDAR sensor detects an object by using light, such that a ghost object may be formed in an empty space due to transmission or reflection of the light. Specifically, the LiDAR sensor may output a point cloud of the ghost object at a position different from the object due to the transmission or reflection caused by the light characteristic unique to the object. For example, during driving of a vehicle, light may be reflected on a glass of another vehicle, a road sign with high reflectance, a water puddle, or the like, such that the point clouds of the LiDAR sensor are clustered in the empty space. The clustered point clouds may act as ghost objects in a learning model for three-dimensional object detection, thereby reducing performance for autonomous driving and training of the learning model.

### SUMMARY

Various examples of the present disclosure are to provide a method and device for removing a ghost object, which improves performance of object detection by removing the ghost object caused by a unique characteristic of a sensor.

Various examples to be solved by the present disclosure are not limited to those mentioned above, and other problems not mentioned will be clearly understood by those of ordinary skill in the art from the following description.

According to the present disclosure, a method performed by an apparatus of a vehicle may comprise obtaining, via a light detection and ranging (lidar) sensor of the vehicle, lidar sensor data associated with an environment of the vehicle, estimating, based on the lidar sensor data, an allowable point distribution from a point distribution assignable to an object associated with a boundary region, generating, based on the allowable point distribution, allowable point distribution data, determining, based on the allowable point distribution data and actual point distribution data of the boundary region, whether the object is a ghost object, removing, based on a determination that the object is the ghost object, the object, outputting a signal indicating the removal of the object, and controlling, based on the signal, an operation of the vehicle.

According to the present disclosure, a vehicle may comprise a sensor configured to provide sensor data associated with an environment of the vehicle, a driving control circuit configured to control autonomous driving of the vehicle, and a processor circuit configured to generate, based on the sensor data, a boundary region corresponding to an object, determine, based on the sensor data, an actual point count associated with the boundary region, determine, based on a resolution of the sensor, an expected point count associated with the boundary region, determine, for the boundary region, a virtual point count defined by a virtual object placed in the boundary region, adjust, based on the virtual point count, the expected point count, compare the actual point count to the adjusted expected point count, determine, based on the comparison, that the object is a ghost object, remove the boundary region based on the determination that the object is the ghost object, output a signal indicating the removal of the boundary region, and control, via the driving control circuit and based on the signal, autonomous driving of the vehicle.

A vehicle may comprise elements configured such that a processor circuit is further configured to scale a size of a virtual object placed in a boundary region. A vehicle may comprise elements configured such that a processor circuit is further configured to align an orientation of a virtual object placed in a boundary region with a heading direction associated with an object. A vehicle may comprise elements configured such that a processor circuit is further configured to determine an adjusted expected point count using a ratio between a virtual point count and an expected point count.

According to the present disclosure, an apparatus of a vehicle may comprise a light detection and ranging (LiDAR) sensor configured to obtain LiDAR sensor data associated with an environment of the vehicle, a processor, and a memory storing at least one instruction that, when executed by the processor, is configured to estimate, based on the LiDAR sensor data, an allowable point distribution from a point distribution assignable to an object associated with a boundary region, generate, based on the allowable point distribution, allowable point distribution data, determine, based on the allowable point distribution data and actual point distribution data of the boundary region, whether the object is a ghost object, remove, based on a determination that the object is the ghost object, the object, output a signal indicating the removal of the object, and control, based on the signal, an operation of the vehicle.

An apparatus of a vehicle may comprise elements configured such that an allowable point distribution is generated based on region allowable distribution data of a boundary region, a region area of the boundary region, and point occupancy data associated with an object, wherein the region allowable distribution data may comprise a point distribution assignable to at least a portion of the boundary region based on specification information of a LiDAR sensor, the region area may comprise an area of a regional face set based on a relative position between the boundary region and the LiDAR sensor, and the point occupancy data may comprise an occupancy area estimated from the point distribution assignable to the object.

An apparatus of a vehicle may comprise elements configured such that at least one instruction, when executed by a processor, is configured to generate, based on region allowable distribution data and a region area, boundary attribute data, generate point occupancy data comprising a point occupancy area of a virtual object placed in a boundary region, wherein the point occupancy area is defined based on virtual points assigned, based on set information associated with an object, to the virtual object, and generate, based on the boundary attribute data and the point occupancy data, allowable point distribution data.

An apparatus of a vehicle may comprise elements configured such that specification information may comprise a resolution of a LiDAR sensor, and region allowable distribution data is generated based on a point distribution assignable to a regional face and the resolution. An apparatus of a vehicle may comprise elements configured such that a regional face is defined by a first line and a second line, wherein the first line connects vertices associated with extension lines that form, for each vertex arranged on a designated face of a boundary region, a maximum angle among angles between the extension lines extending from the vertices toward a LiDAR sensor, and wherein the second line is a line of the boundary region that extends in a direction different from the designated face and is positioned at a shortest distance from the LiDAR sensor among a plurality of lines of the boundary region, wherein the plurality of lines comprises a vertex arranged on the designated face.

An apparatus of a vehicle may comprise elements configured such that boundary attribute data is generated using a portion of a boundary region that is not occluded by another boundary region of another object, wherein the portion is identified based on at least a portion of LiDAR sensor data associated with the boundary region, and wherein the portion is not included in LiDAR sensor data associated with the other boundary region. An apparatus of a vehicle may comprise elements configured such that at least one instruction, when executed by a processor, is configured to identify, for each section of a plurality of sections arranged at equal intervals on a virtual object, a maximum height point and a minimum height point among virtual points corresponding to the section, generate, based on the maximum height point and the minimum height point, a section area for each section, and generate, based on the section areas of the plurality of sections, point occupancy data comprising an occupancy area.

An apparatus of a vehicle may comprise elements configured such that an allowable point distribution corresponds to an expected point count associated with a boundary region, and allowable point distribution data corresponds to an adjusted expected point count obtained by adjusting the expected point count based on a virtual point count of a virtual object positioned within the boundary region. An apparatus of a vehicle may comprise elements configured such that a virtual object is adjusted to conform to a boundary region, and set information comprises a resolution of a LiDAR sensor. An apparatus of a vehicle may comprise elements configured such that at least one instruction, when executed by a processor, is configured to control driving of the vehicle based on object detection information from which a ghost object has been removed.

The features briefly summarized above for this disclosure are only examples of the detailed description of the disclosure which follow and are not intended to limit the scope of the disclosure.

### BRIEF DESCRIPTION OF THE DRAWINGS

FIG. 1 shows an example of modules constituting a device for removing ghost objects.

FIG. 2 shows an example of a method for removing ghost objects.

FIG. 3 is shows an example of detected points and a boundary region.

FIG. 4 is shows an example of a process for identifying lines in a first direction.

FIG. 5 is shows an example of a process for identifying lines in a second direction.

FIG. 6 is shows an example of resolution in the first direction.

FIG. 7 is shows an example of resolution in the second direction.

FIG. 8 is shows an example of a virtual object positioned within a boundary region.

FIG. 9 is shows an example of virtual points overlapping a virtual object.

FIG. 10 is shows an example of a process for generating point occupancy data.

FIG. 11 is shows an example of a vehicle communicating with another device to transmit and receive data.

FIG. 12 shows an example of modules constituting a vehicle.

FIG. 13 shows an example of computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., Ghost Object Removal via Expected LiDAR Point Distribution) described herein, an operation of the vehicle may be controlled. For example, when expected-distribution analysis removes a ghost object falsely detected ahead, the autonomous driving controller may prevent unnecessary braking or lane-change requests. Conversely, when the feature confirms that an obstacle is real, the controller may adjust forward-collision warning timing or increase braking readiness (e.g., earlier deceleration or heightened hazard alerts).

One or more auxiliary devices (e.g., engine brake, exhaust brake, hydraulic retarder, electric retarder, regenerative brake, etc.) may also be controlled, for example, based on one or more features (e.g., Ghost Object Removal via Expected LiDAR Point Distribution). For example, when expected-point analysis determines that a detected obstacle is a ghost object, the vehicle may reduce unnecessary deceleration (e.g., suppressing engine-brake activation). Conversely, when the feature confirms the presence of a real obstacle, auxiliary braking devices may be pre-activated (e.g., applying a regenerative brake or hydraulic retarder) to enhance early slowdown.

One or more communication devices (e.g., a modem, a network adapter, a radio transceiver, an antenna, etc.) may also be controlled, for example, based on one or more features (e.g., Ghost Object Removal via Expected LiDAR Point Distribution). For example, when expected-point analysis identifies a detected obstacle as a ghost object, the vehicle may suppress non-essential V2X alerts (e.g., false hazard broadcasts) or reduce uplink bandwidth usage by omitting ghost-object reports. Conversely, when the feature confirms a true object, the communication device may transmit prioritized messages (e.g., collision warnings or cooperative perception packets) to nearby vehicles or infrastructure.

Minimum risk maneuver (MRM) operation(s) may also be controlled, for example, based on one or more features (e.g., Ghost Object Removal via Expected LiDAR Point Distribution). For instance, when expected-point analysis determines that an obstacle ahead is a ghost object (e.g., fewer than a threshold number of LiDAR points or inconsistent occupancy sections), the vehicle may delay or cancel an unnecessary MRM, such as an abrupt stop or emergency lane pull-over. Conversely, when the feature confirms a true object with a valid expected point distribution, the vehicle may initiate an MRM earlier—such as gradually decelerating, pulling to the shoulder, or maintaining a low-speed stop—to minimize collision risk.

Biased driving operation(s) may also be controlled, for example, based on one or more features (e.g., Ghost Object Removal via Expected LiDAR Point Distribution). For instance, when the expected-point analysis determines that an obstacle detected near a lane boundary is a ghost object (e.g., fewer than 20% of expected LiDAR points, inconsistent section heights, or sparse occupancy area), the driving control apparatus may apply a reduced lateral bias or return the vehicle toward the lane center because no real obstacle needs avoidance. Conversely, when a true object is confirmed near an adjacent lane, the apparatus may increase the lateral bias (e.g., shifting 10–30 cm away from the object) to maintain a safer gap during straight driving or a lane change.

One or more sensors (e.g., IMU sensors, camera, LiDAR, RADAR, blind-spot monitoring sensor, line-departure warning sensor, parking sensor, light sensor, rain sensor, traction control sensor, anti-lock braking system sensor, tire-pressure monitoring sensor, seatbelt sensor, airbag sensor, fuel sensor, emission sensor, throttle-position sensor, inverter, converter, motor controller, power distribution unit, high-voltage wiring and connectors, auxiliary power modules, charging interface, etc.) may also be controlled, for example, based on one or more features (e.g., Ghost Object Removal via Expected LiDAR Point Distribution). For instance, when expected-point analysis indicates that a detected obstacle is likely a ghost object (e.g., fewer than 20% of expected LiDAR points, abnormal section-height discrepancies, or inconsistent point density across sections), the system may adjust sensor operations—such as lowering LiDAR pulse intensity to reduce noise, increasing camera frame rate for cross-validation, or re-prioritizing RADAR tracking—to avoid misallocating sensing resources. Conversely, when a true object is confirmed, the system may increase LiDAR scan density or activate additional sensors to enhance object classification accuracy.

An autonomous driving level and/or autonomous driving activation/deactivation may also be controlled based on one or more features (e.g., Ghost Object Removal via Expected LiDAR Point Distribution) described herein. For example, when the ghost-object likelihood for a detected object exceeds a threshold (e.g., less than 20% of expected LiDAR points, abrupt point-density loss, or repeated occlusion events), the driving control apparatus may temporarily lower the autonomous driving level, request increased driver attentiveness (e.g., hands-on reminder or look-ahead prompt), or deactivate autonomous driving to avoid reacting to a false obstacle. Conversely, when ghost-object removal confirms that no false object is present, the driving control apparatus may maintain or increase the autonomous driving level.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

According to the present disclosure, a vehicle using LiDAR sensors may sometimes detect “ghost objects,” which are false objects that appear when the LiDAR’s light reflects off shiny or transparent surfaces such as windows, signs, or water puddles. These false detections can make it difficult for autonomous-driving systems to correctly understand the surrounding environment. To address this issue, the present disclosure describes a technique that examines each detected object to determine whether it is likely to be real or simply a reflection-based ghost object. The technique does this by placing a virtual object model inside the region where the sensor believes an object exists, estimating how many LiDAR points a real object should generate, and comparing that estimate to the actual number of points detected. When the actual points are too few for a real object, the system treats the detection as a ghost object and removes it. By filtering out ghost objects in this manner, the disclosed approach improves the reliability of object detection and supports safer autonomous-driving decisions.

Hereinafter, examples of the present disclosure will be described with reference to the accompanying drawings.

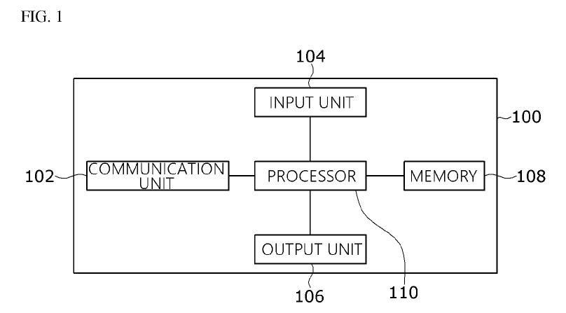

Hereinafter, a device for removing a ghost object according to an example of the present disclosure will be described with reference to FIG. 1. FIG. 1 shows an example of modules constituting a device for removing ghost objects according to an example of the present disclosure.

Referring to FIG. 1, the device 100 for removing a ghost object may detect at least one object based on LiDAR sensor data obtained by a LiDAR sensor while the device equipped with the LiDAR sensor moves and remove the ghost object from among the detected objects. Hereinafter, for convenience of description, the device 100 for removal of a ghost object may be abbreviated as a removal device.

The LiDAR sensor data may receive light emitted from the LiDAR sensor and reflected from an object and generate a point cloud based on the received light. The removal device 100 may recognize the object based on the LiDAR sensor data by using a learning model. The learning model may be, for example, a deep learning-based object detection network or an object detection model (e.g., PointPillars, PointNet++, CenterPoint, or SECOND, etc.). In the present disclosure, the learning model may be referred to as a network, a learning network, a model, or an algorithm.

The learning model may estimate a boundary region three-dimensionally surrounding the detected object, a position of the object, a heading angle, a size, and a type (or class) based on the point cloud (e.g., vehicle, pedestrian, cyclist, or debris, etc.). Data output from the learning model may constitute object detection information. The detected object is provided in a three-dimensional space, and the boundary region may be, for example, a bounding box (e.g., cuboid box, oriented 3D box, or rotated box, etc.). For example, the position of the object may be described as a three-dimensional position corresponding to the center of the boundary region, and the size of the object may, for example, be described as a width, a length, and a height in the boundary region (e.g., 1.8 m × 4.5 m × 1.6 m for a sedan, 2.5 m × 12 m × 3 m for a truck, etc.). The object detection information may be generated while the device equipped with the removal device 100 moves in real time or may be provided as ground truth data labeled in advance for use in training of the learning model (e.g., KITTI, or Waymo labels, etc.).

As an example, the removal device 100 may generate object detection information based on LiDAR sensor data transmitted from an external device equipped with a LiDAR sensor while moving in a real environment (e.g., urban roads, highways, or warehouse aisles, etc.). The object detection information may be generated by a learning model. The removal device 100 may remove a ghost object from the object detection information. The removal device 100 may train the object detection model based on the object detection information from which the ghost object has been removed. The removal device 100 may transmit the trained object detection model to the vehicle 200, such that the vehicle 200 may recognize an object using the model and control the vehicle based on the recognized object.

In another example, the removal device 100 may receive object detection information generated based on the LiDAR sensor data from an external device and remove a ghost object from the object detection information. The object detection information from which the ghost object is removed may be utilized in the same manner as in one example.

Yet another example, the removal device 100 may be provided in a vehicle that uses LiDAR sensor data obtained from the LiDAR sensor for driving control (e.g., lane keeping, obstacle avoidance, or parking assist, etc.). The LiDAR sensor may be mounted on the vehicle or the removal device 100. The removal device 100 may generate object detection information based on the LiDAR sensor data by using a learning model. The removal device 100 may remove a ghost object from the object detection information. The removal device 100 may control an operation, for example, driving, of the vehicle based on the object detection information from which the ghost object is removed.

Meanwhile, the vehicle 200 that generates the object detection information from which the ghost object is removed or receives the learning model trained by the information may refer to a movable device. The vehicle 200 is a ground vehicle that drives on the ground, and may be a normal passenger or commercial vehicle, a Purpose-Built Vehicle (PBV), or the like (e.g., sedans, taxis, delivery vans, or shuttles, etc.). The vehicle 200 may be a robot in a broad sense, such as a moving means, and the robot may be moved using wheels, tracks, or other moving modules (e.g., omni-wheels, crawler tracks, or articulated legs, etc.). The vehicle 200 may be autonomously or passively driven.

The autonomously driven vehicle 200 may be implemented as semi-autonomous driving or fully autonomous driving. The fully autonomous driving may be provided as autonomous movement in which the vehicle 200 completely controls without user intervention, even if the driving situation is uncertain (e.g., dense traffic, nighttime roads, or adverse weather, etc.). The semi-autonomous driving may be provided in autonomous movement in which driver intervention is required according to a specific driving situation.

The removal device 100 may be, for example, a device, such as a server, provided separately from the vehicle 200 to be operated by a vehicle manufacturer or operated by a management agency that provides an autonomous driving service (e.g., fleet management center, cloud inference server, or OEM backend system, etc.). The server (see 100 in FIG. 11) may not only provide a learning model trained by object detection information excluding a ghost object but also transmit an application supporting various functions of the vehicle 200 to the vehicle. When the server 100 is operated by the vehicle manufacturer or the management agency that supports autonomous driving, it may receive connected data of the vehicle 200 or transmit data necessary for autonomous driving. The server 100 may transmit various information and software modules used for controlling the vehicle 200 to support autonomous driving and various services of the vehicle 200 in response to a request and data transmitted from the vehicle 200 and a user device. In the present disclosure, a function of removing a ghost object among various functions of the server will be described.

The removal device 100 may include a communication unit 102, an input unit 104, an output unit 106, a memory 108, and a processor 110.

The communication unit 102 may support mutual communication with an external device, a vehicle 200, 400, or the like. In the present disclosure, the communication unit 102 may be a communication interface that receives time-series image data of a camera received from the external device or the vehicle 200, 400 (e.g., stereo frames, fisheye images, or panoramic frames, etc.). The communication interface may transmit a parameter of the camera estimated using the image data, for example, pose information, to the camera or the vehicle 200 or 400.

The input unit 104 may include an interface for receiving a request from a user, and the output unit 106 may include an interface that visually provides information generated according to the present disclosure. The information may include, for example, object detection information in which a ghost object is removed and intermediate data output in a process of removing the ghost object (e.g., filtered point clouds, occupancy maps, or confidence scores, etc.).

The memory 108 stores a program and various data for controlling the removal device 100, such that the program may be loaded, or the data may be read and written at the request of the processor 110.

In the present disclosure, the memory 108 may hold an application or a software module that removes a ghost object from object detection information based on at least LiDAR sensor data (e.g., raw scans, accumulated scans, or sector-wise scans, etc.). The memory 108 may store a learning model that outputs object detection information for object recognition based on the LiDAR sensor data.

The processor 110 may perform overall control of the removing device 100. The processor 110 may be configured to execute an application and an instruction stored in the memory 108. In detail, the processor 110 may execute processing of generating, according to set information, allowable point distribution data based on an allowable point distribution estimated from a point distribution assignable to an object related to a boundary region based on LiDAR sensor data. The processor 110 may perform processing of determining whether the object in the boundary region is a ghost object based on the allowable point distribution information and actual point distribution data of the boundary region. In addition, the processor 110 may perform the processing of removing the object determined as the ghost object from the object detection information.

Thereafter, as an example, the processor 110 may train the learning model and transmit the learning model to the vehicle 200 by using, as ground truth data, the object detection information on which the removal of the ghost object has been processed (e.g., corrected labels, cleaned bounding boxes, or refined class tags, etc.). As another example, the processor 110 may control the operation, for example, driving, of the vehicle 200 including the processor 110 based on the object detection information from which the ghost object is removed. Details of the above-described processes by the processor 110 will be described later.

In the present disclosure, as an example, the processor 110 may be implemented as a single processing module. As another example, the processing according to the foregoing may be distributed in a plurality of processing modules (e.g., front-end processor, feature extractor, or decision module, etc.), and the processor 110 may also be collectively referred to as a plurality of processing modules in the present disclosure.

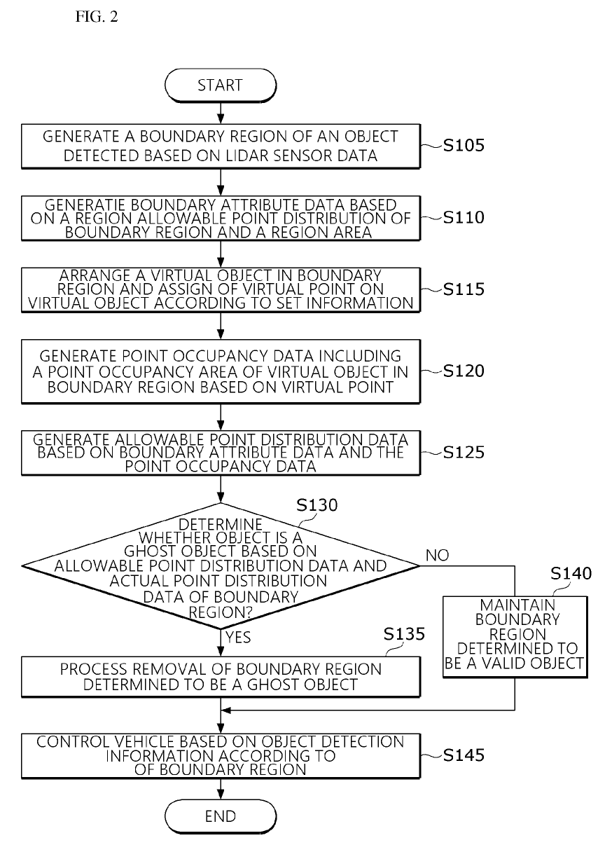

Hereinafter, a method of removing a ghost object according to another example of the present disclosure will be described with reference to FIGS. 2-9. FIG. 2 shows an example of a method for removing ghost objects according to another example of the present disclosure. Hereinafter, the method may be described as being performed by the removal device 100 that receives LiDAR sensor data for detecting a surrounding environment from an external device and excludes the ghost object from object detection information generated based on the LiDAR sensor data (e.g., raw scans, accumulated scans, or sector-wise scans, etc.). However, the following description may be applied to a device or a vehicle 200 that receives object detection information from an external device unless technically contradictory. The method is performed by the processor 110 of the removal device 100, but the processor 110 may be abbreviated as the removal device 100 for convenience of description, or these terms may be used interchangeably.

Referring to S105 of FIG. 2, the processor 110 of the removal device 100 may recognize at least one object based on the LiDAR sensor data by using a learning model for object detection, thereby generating at least one object detection information including a boundary region of the object (e.g., for vehicles, pedestrians, cyclists, or obstacles, etc.).

The learning model may be, for example, a deep learning-based object detection model, and the LiDAR sensor data may be a point cloud formed based on light received by reflecting light emitted from the LiDAR sensor from an object. As a specific example, the learning model may include an encoder including a convolution layer and a filter to extract features from the LiDAR sensors data, and a decoder that outputs object detection information based on the features (e.g., CenterPoint encoder–decoder, PointPillars backbone, or voxel-based networks, etc.).

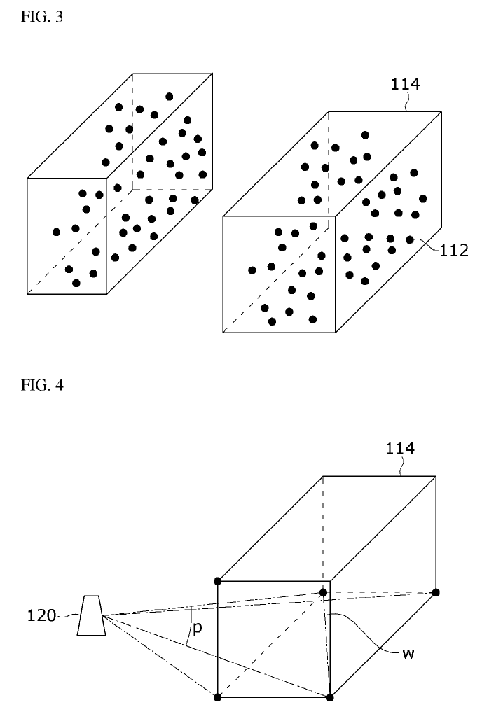

As illustrated in FIG. 3, the object detection information may include a boundary region 114 that three-dimensionally surrounds an object in a three-dimensional space. FIG. 3 is shows an example of detected points and a boundary region (e.g., an axis-aligned box, an oriented 3D box, or a cuboid region, etc.). The boundary region 114 may be represented by, for example, a bounding box. The boundary region 112 may be generated to estimate an object recognized by clustering of points 112 that detect the object and include the points 112 associated with the estimated object. Although two boundary regions 114 are illustrated in FIG. 2 for convenience of illustration, a plurality of boundary regions 114 may be generated. In addition, the object detection information may include, for example, positions, heading angles, sizes, and types of objects (e.g., vehicle class, truck class, bicycle class, or pedestrian class, etc.). The positions of the objects are described as, for example, three-dimensional positions corresponding to the centers of the boundary regions 114, and the sizes of the objects may be described as widths, lengths, and heights in the boundary regions, for example (e.g., 2 m × 5 m × 1.5 m for a sedan, 1 m × 1 m × 2 m for a pedestrian, etc.). The types of objects may be, for example, vehicles, motorcycles, bicycles, or the like, and may be provided in various classes.

Referring to S110 of FIG. 2, the processor 110 may generate the boundary attribute data based on the region allowable distribution data of the boundary region 114 according to the specification information of the LiDAR sensor and the region area of the boundary region.

The region allowable distribution data may include a distribution of points assignable to at least a portion of the boundary region 114 according to specification information of the LiDAR sensor (e.g., vertical resolution, horizontal resolution, or laser channel spacing, etc.). The specification information may include, for example, a resolution of the LiDAR sensor. For example, the region allowable distribution data may be generated based on a distribution of points assignable to the regional face according to the resolution. The region allowable distribution data may be generated based on the distribution of points assigned to the entire regional face, rather than a distribution of points in a portion occupied by an object in the regional face. The distribution of points may be, for example, the number or density of points, or the like (e.g., 15 points/m², 20 points/m², or sparse distributions, etc.). In the present disclosure, for convenience of description, the distribution of points may be illustrated as being the number of points.

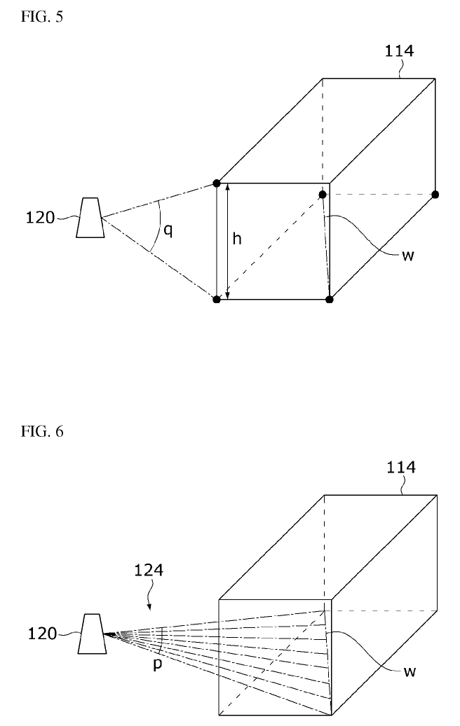

The regional face may be set based on a relative position between the boundary region 114 and the LiDAR sensor. The setting of the regional face will be described with reference to FIGS. 4 and 5. FIG. 4 is shows an example of a process for identifying lines in a first direction. FIG. 5 is shows an example of a process for identifying lines in a second direction.

Referring to FIG. 4, the processor 110 may adopt vertices 116 associated with extension lines forming a maximum angle p among angles between the extension lines connected to the LiDAR sensor 120 for each vertex 116 arranged on a designated face of the boundary region 114 (e.g., bottom face, side face, or top face, etc.). In FIG. 4, a designated face may be a lower section of the boundary region 112, that is, a bottom face. The designated face may be selected as another face in addition to the bottom face illustrated in FIG. 4 according to a relative position between the boundary region 114 and the LiDAR sensor 120. The processor 110 may adopt a line connecting the vertices of the extension lines forming the maximum angle p as a first direction line w. The first direction line w may be referred to as a lateral line in the present disclosure. An angle between the extension lines extending from each of the vertices 116 of the first direction line w to the LiDAR sensors 120 is the above-described maximum angle and may be the first direction angle p. The first direction angle p may be referred to as a lateral angle in the present disclosure.

Referring to FIG. 5, the processor 110 may adopt a line of the boundary region 114 disposed at the shortest distance from the LiDAR sensor 120 from among lines of the boundary region extending in a direction different from the designated face and having the vertex 116 arranged on the designated face (e.g., a front edge, a rear edge, or a side edge, etc.). The processor 110 may adopt the line adopted by being disposed at the shortest distance as a second direction line h. The second direction line h may be referred to as a longitudinal direction line in the present disclosure. An angle between extension lines extending from each of the vertices 116 of the second direction line h to the LiDAR sensor 102 may be a second direction angle q. The second direction angle q may be referred to as a longitudinal direction angle in the present disclosure.

According to examples in FIGS. 4 and 5 , the regional face may be a face defined by the first direction line w and the second direction line h. Specifically, the regional face may be a face virtually formed by using the first direction line w and the second direction line h as horizontal and vertical, respectively, to correspond to a face cut along a diagonal direction of the boundary region 114. Using the second direction line has a vertical line of the regional face may mean using the longitudinal line parallel to the second direction line h. The longitudinal line may be, for example, a line of the boundary region 114 extending in a direction perpendicular to the first direction line w, that is, a direction parallel to the second direction line h, while sharing at least one of both vertices of the first direction line w.The processor 110 may generate the region allowable distribution data based on the distribution of points assignable to the regional face according to the resolution of the LiDAR sensor 120 (e.g., 0.1° vertical resolution, 0.2° horizontal resolution, or multi-channel spacing, etc.).

For example, the resolution may be expressed as a first direction resolution and a second direction resolution by dividing the scanning channel information of the LiDAR sensor 120 into a first direction angle p according to the first direction line w and a second direction angle q according to the second direction line h (e.g., lateral field of view vs. longitudinal field of view, etc.).

As illustrated in FIG. 6, the first direction resolution 124 may represent scanning channel information at an angle that divides the first direction angle p. FIG. 6 is shows an example of resolution in the first direction. The scanning channel information is, for example, the number of scanning channels, such as 128 channels, and the first direction resolution 124 may be represented as, for example, 0.2 degrees (e.g., 0.16°, 0.2°, or 0.4°, etc.). The first direction resolution 124 may be referred to as a lateral resolution in the present disclosure.

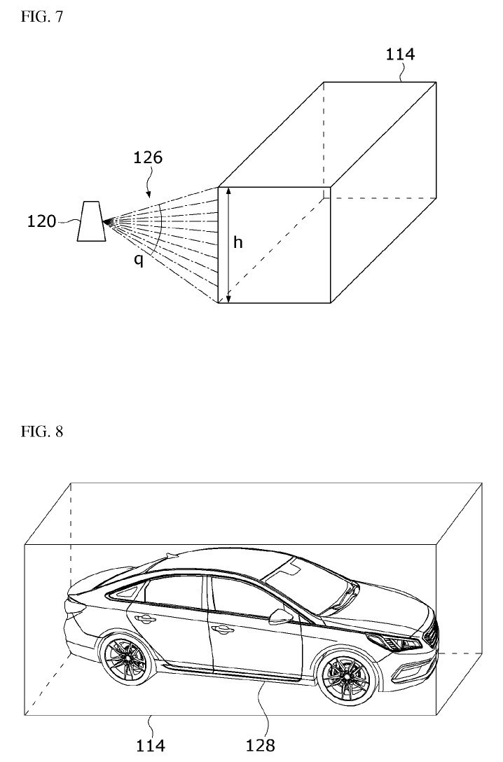

As illustrated in FIG. 7, the second direction resolution 126 may represent scanning channel information at an angle that divides the second direction angle q. FIG. 7 is shows an example of resolution in the second direction. The second direction resolution 126 may be represented as, for example, 0.125 degrees (e.g., 0.1°, 0.125°, or 0.2°, etc.). The second direction resolution 126 may be referred to as a longitudinal resolution in the present disclosure.

The processor 110 may generate data related to a distribution of points, e.g., the number of points, assignable to the regional face based on the first direction angle p, the first direction resolution 124, the second direction angle q, and the second direction resolution 126 (e.g., by computing expected point density, expected coverage, or expected sampling rate, etc.). In detail, the processor 110 may generate the data related to the number of points assignable by the resolution in the regional face by using Equations [first direction angle p/first direction resolution 124] X [second direction angle q/second direction resolution 126]. The processor 110 may generate the region allowable distribution data based on the data related to a number of points. The region allowable distribution data may be generated based on the number of points assigned to the entire regional face, not the number of points in a portion occupied by an object in the regional face.

The processor 110 may generate a region area based on the area of the regional face defined by the first and second direction lines p and q shown in FIGS. 4 and 5 (e.g., rectangular faces, slanted faces, or top-view faces, etc.). The processor 110 may provide boundary attribute data having region allowable distribution data and region area.

Meanwhile, the processor 110 may generate boundary attribute data for the boundary region 114 that is not occluded by another boundary region of another object. Specifically, the processor 110 may identify the boundary region 114 as being not occluded based on at least a portion of the LiDAR sensor data of the boundary region 114 not being present in the other boundary region (e.g., no overlapping points, no intersecting edges, or no blocking surfaces, etc.).

For example, the processor 110 may determine that the boundary region 114 is occluded by another object based on identifying that a point of another object exists in the first direction line w of the boundary region 114 shown in FIG. 4. The processor 110 may not perform the generation processing of the boundary attribute data in S110 on the occluded boundary region 114. When the object or the boundary region 114 becomes occluded, the object may be located far away from the vehicle (or the host vehicle), or may be obscured by another object (e.g., trucks, buses, or roadside structures, etc.). In a case in which the object or the boundary region 114 becomes occluded, the region allowable point distribution may not be accurate. Accordingly, it is determined that the occlusion object or boundary region 114 does not correspond to an object for which detection is essential, and thus the generation processing of boundary attribute data may not be performed on the object.

Referring back to S115 of FIG. 2, the processor 110 of the removal device 100 may place a virtual object associated with the object in the boundary region 114, and assign a virtual point on the virtual object according to the set information (e.g., CAD model points, mesh-based points, or sampled surface points, etc.).

As illustrated in FIG. 8, if the class and specification data of the object is a vehicle of a particular manufacturer, the processor 110 may search for and load a virtual object 128 associated with the particular vehicle stored in the memory 108, based on the class and specification of the object data (e.g., sedan shape, SUV shape, or truck shape, etc.). The processor 110 may place the loaded virtual object 128 in the boundary region 114. FIG. 8 is shows an example of a virtual object positioned within a boundary region.

For example, the virtual object 128 may have a single size regardless of the size of the boundary region 114 (e.g., fixed template shape or standard vehicle model, etc.). The virtual object 128 may be provided, for example, through CAD modeling. The processor 110 may adjust the virtual object 128 having a single size to match the boundary region 114 based on the object detection information related to the boundary region 114, to arrange the virtual object 128 whose size is adjusted in the boundary region 114.

Taking the placement of the virtual object 128 as an example, the processor 110 may place the virtual object 128 related to or similar to the object at the center point of the three-dimensional space where the boundary region 114 exists, based on the class of the object in the object detection information (e.g., car-class center, box center, or point-cluster center, etc.). The processor 110 may adjust the size of the virtual object 128 to maximize the size of the boundary region 114, based on the size of the boundary region in the object detection information. Accordingly, the virtual object 128 may be enlarged or reduced to match the size of the boundary region 114. In addition, the processor 110 may rotate the header of the adjusted virtual object 128 to correspond to the boundary region 114 based on the heading angle of the object in an object detection information (e.g., 0°, 45°, or 90° yaw alignment, etc.). As illustrated in FIG. 8, the processor 110 can arrange the virtual object 128 subjected to the heading processing in the boundary region 114 in the three-dimensional space. Here, the processor 110 can align the virtual object 128 with the boundary region 114 such that the center of the virtual object 128 is arranged at the center of the boundary region (e.g., center-to-center alignment along x, y, and z, etc.).

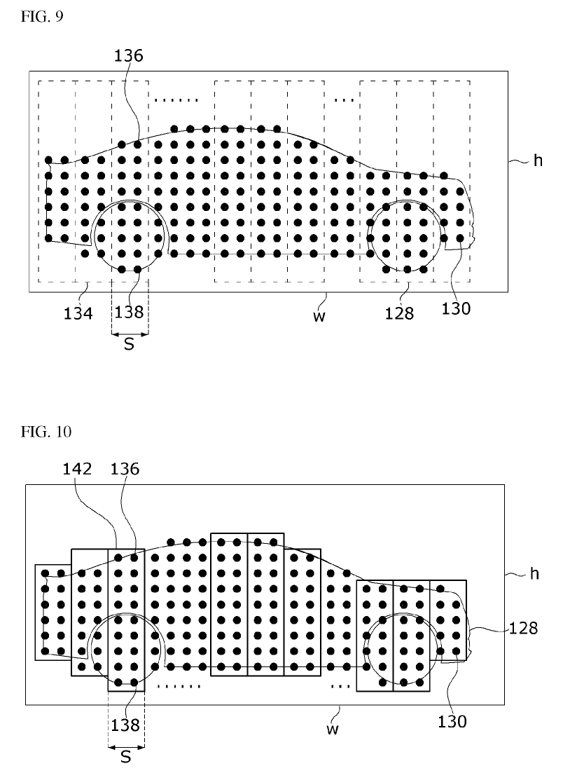

As illustrated in FIG. 9, the processor 110 may assign or superimpose the virtual points 130 for each of a plurality of sections 134 arranged at equal intervals on the virtual object 128 (e.g., uniform angular slices, radial slices, or grid-based segments, etc.). FIG. 9 is shows an example of virtual points overlapping a virtual object. Each section 134 may be equally divided at an interval s of 0.5 degrees, for example, like a cylindrical coordinate system employing the LiDAR sensor 120 as an origin (e.g., angular sectors of 0.5°, 1°, or 2°, etc.). According to this example, the section interval s may be derived by an equation (length of the first direction line w X first direction angle p)/0.5. The above-described interval s for each section is merely an example and may be set in consideration of computational resources (e.g., GPU load, memory limits, or frame rate constraints, etc.).

The virtual point 130 may be assigned to the virtual object 128 arranged on the regional face according to the set information (e.g., LiDAR vertical resolution, horizontal resolution, or user-defined sampling density, etc.). The regional face may be a face defined by the first direction line w and the second direction line h, as described in S110. The set information may include, as an example, a resolution of the LiDAR sensor 120. The resolution may be according to the first and second direction resolutions 124, 126 described in S110. As another example, the set information may include a resolution or the number of points separately designated by the user or the processor 110 (e.g., selecting 100, 200, or 300 sample points, etc.).

According to the above, the superposition of the virtual points 130 may be implemented on the portion of the regional face occupied by the virtual object 128, rather than on the entire regional face, as illustrated in FIG. 9 (e.g., only the silhouette region, shape-matched area, or projected footprint, etc.)..

Referring to S120 of FIG. 2, the processor 110 may generate, based on the virtual point 130, point occupancy data including a point occupancy area of the virtual object 128 in the boundary region 114.

As illustrated in FIG. 9, the processor 110 may identify a maximum height point 136 and a minimum height point 138 from among the virtual points 130 for each of the plurality of sections 134 arranged on the virtual object 128 of the regional face (e.g., highest roofline point, lowest chassis point, or lowest bumper point, etc.).

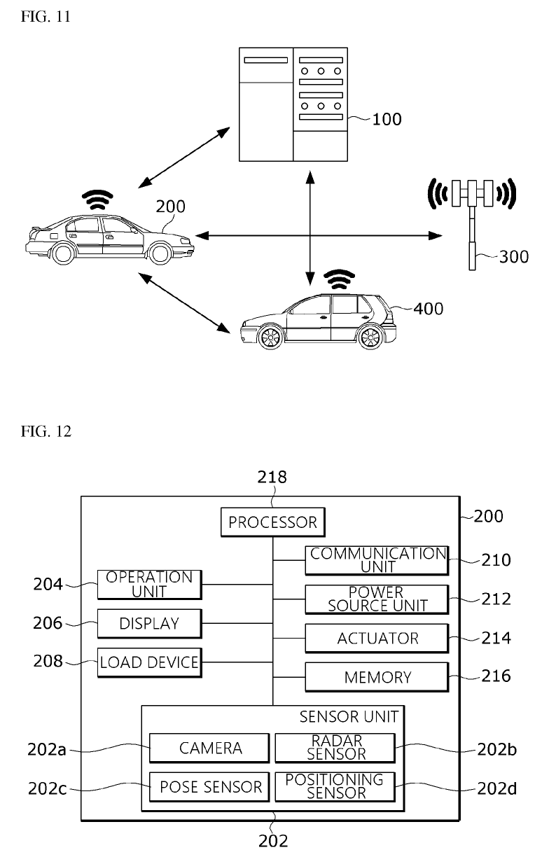

As illustrated in FIG. 10, the processor 110 may generate a section area 142 for each section 134 based on a section height matching the maximum height point 136 and the minimum height point 138. FIG. 10 is shows an example of a process for generating point occupancy data. The processor 110 may generate point occupancy data including an occupancy area generated based on the section area 142 of each section. The section area 142 may be derived by a product of a section height and a section interval s. The point occupancy data may be generated by summing all the section areas 142 (e.g., summing footprints, summing cross-sections, or integrating heights, etc.).

Accordingly, the point occupancy data may be generated to have an occupancy area estimated from the point distribution assignable to the object, according to the set information (e.g., expected sampling density or expected LiDAR coverage, etc.).

Referring to S125 of FIG. 2, the processor 110 may generate allowable point distribution data based on the boundary attribute data and the point occupancy data.

The allowable point distribution data may be generated based on an occupancy ratio of the occupancy area of the point occupancy data for the region area and the region allowable point distribution. The allowable point distribution data and the region allowable point distribution may be, for example, a number of points or a point density (e.g., points/m², expected beam hits, or expected sampling rate, etc.). In the present disclosure, for convenience of description, the data and the distribution described above may be illustrated as being the number of points. According to this example, the allowable point distribution information may be derived as the number of allowable points that may be occupied by the virtual object 128 of the regional face by a product of the number of points and the occupancy ratio of the region allowable points distribution.

According to the above, it may be seen that the allowable point distribution data is generated based on the allowable point distribution estimated from the maximum assignable point distribution to the object related to the boundary region 114, according to the set information (e.g., expected coverage calculated from the object size, face area, or virtual model geometry, etc.).

Referring to S130 of FIG. 2, the processor 110 may determine, based on the allowable point distribution data and the actual point distribution data of the boundary region 114, whether the object in the boundary region 114 is a ghost object.

The actual point distribution data may relate to a distribution of points detected at the LiDAR sensor 120 shown in FIG. 3 (e.g., raw point count, raw point density, or actual beam returns, etc.). For example, the actual point distribution data may be a number of actual points or an actual point density. In the present disclosure, for convenience of description, the actual point distribution data may be illustrated as being the number of actual points.

When the ratio of the number of points in the point distribution data to the number of points of the allowable point distribution data is equal to or less than the threshold value, the processor 110 may determine that the object in the boundary region 114 is a ghost object (e.g., ratio ≤ 20%, 30%, or 40%, etc.). On the other hand, when the ratio exceeds the threshold value, then the processor 110 may also determine that the object of the boundary region 114 does not correspond to a ghost object.

Referring to S135 of FIG. 2, the processor 110 may remove the boundary region and the object determined to be the ghost object from the three-dimensional space and the object detection information, based on determining the object in the boundary region 114 as the ghost object (e.g., delete the bounding box, clear the point cluster, or omit the detection output, etc.).

Referring to S140 of FIG. 2, the processor 110 may maintain the boundary region and the object in the three-dimensional space and object detection information based on not determining the object in the boundary region 114 as a ghost object (e.g., retain the 3D box, preserve object attributes, or forward the detection to downstream modules, etc.).

S110 to S140 in FIG. 2 may be performed on a plurality of boundary regions at the same time, as an example. As another example, the S110 to the S140 may be performed on some of the plurality of boundary regions first, and the S110 to the S140 are repeatedly performed on the remaining boundary regions (e.g., batch mode, sequential mode, or prioritized mode, etc.).

Referring to S145 of FIG. 2, the processor 110 may use the object detection information different from the processing of the boundary region in S135 and/or S140 as ground truth data, train a learning model, and transmit the learning model to the vehicle 200. The vehicle 200 may control an operation, for example, driving, of the vehicle 200 based on the learning model (e.g., obstacle avoidance, path planning, or collision prevention, etc.).

With reference to FIG. 2, a vehicle 200 that receives a learning model trained using object detection information from which a ghost object has been removed from a server 100 (removal device) or directly removes a ghost object from object detection information based on a LiDAR sensor and another device that communicates with the server 100 will be described.

FIG. 11 is shows an example of a vehicle communicating with another device to transmit and receive data.

The vehicle 200 may refer to a device that may move to a specific point, as described above. Although the present disclosure describes the vehicle 200 as a vehicle driving on the ground as an example, the present disclosure may also be applied to a mobility device for flight or water traffic (e.g., drones, air taxis, or autonomous boats, etc.). The vehicle 200 may be controlled to drive by autonomous driving, as described above in FIG. 1, and the autonomous driving may be implemented as semi-autonomous driving or fully autonomous driving (e.g., driver-assist Level 2, highway pilot Level 3, or full Level 4 autonomy, etc.).

The vehicle 200 may be driven based on electric energy or fossil energy. In the case of electric energy, the vehicle 200 may employ, for example, a pure battery-based vehicle driven only by a high-voltage battery or a gas-based fuel cell as an energy source (e.g., lithium-ion battery, solid-state battery, or hydrogen PEM fuel cell, etc.). In addition, the fuel cell may use various types of gases capable of generating electric energy, and the gas may be hydrogen as an example. However, various gases are applicable without being limited thereto (e.g., methanol reformate, biogas, or ammonia-derived hydrogen, etc.). In the case fossil energy, the vehicle 200 is driven based on a fuel such as gasoline, light oil, or liquefied gas, and may be equipped with an engine that drives a wheel included in the actuator 214 by combustion of the fuel (e.g., gasoline engine, diesel engine, or LPG engine, etc.). The engine may be included in the power source unit 212 from the viewpoint of providing the driving rotational force of the wheel to the actuator 214. As another example, the vehicle 200 may also be driven in a hybrid manner of electric energy and fossil energy (e.g., plug-in hybrid, mild hybrid, or series hybrid, etc.).

Meanwhile, the vehicle 200 may perform communication with the other devices 100, 300 or the other vehicle 400. The other devices may include, for example, the removal device 100 that supports various controls, state management, and driving of the vehicle 200, the ITS device 300 for receiving information from the ITS, various types of user devices, and the like (e.g., smartphones, tablets, or navigation units, etc.). The removal device 100 may be an external device operated by, for example, a vehicle manufacturer or a management agency providing autonomous driving services, as described above in FIG. 1.

The ITS device 300 is, for example, a Road Side Unit (RSU), and the ITS device 300 may interchange vehicle recognition data, driving control and state data, environmental data around the vehicle, map data, and the like through V2I with the vehicle 200 to assist the user in driving the own vehicle or support autonomous driving of the vehicle 200 (e.g., lane-level map updates, traffic signal status, or accident alerts, etc.). The vehicle 200 may interchange the above-listed data through V2V with the other vehicle 400 to support driving of the own vehicle or autonomous driving (e.g., cooperative lane change, emergency braking alerts, or blind-spot warnings, etc.).

The vehicle 200 may communicate with other vehicles or other devices based on cellular communication, Wireless Access in Vehicular Environment (WAVE) communication, Dedicated Short Range Communication (DSRC) or near field communication, or other communication schemes (e.g., UWB, Bluetooth, or Wi-Fi Direct, etc.).

For example, for the vehicle 200 to communicate with the server 100, the ITS device 300, and the other vehicle 400, a communication network such as LTE or 5G, WiFi communication network, WAVE, or the like may be used as a cellular communication network (e.g., LTE-V2X, 5G NR-V2X, or WiFi 6, etc.). For another example, DSRC or the like used in the vehicle 200 may also be used for communication between vehicles. A communication manner between the vehicle 200, the server 100, ITS device 300 and another vehicle 400, and a user device is not limited to the foregoing example.

FIG. 12 shows an example of modules constituting a vehicle according to the present disclosure.

The vehicle 200 may include a sensor unit 202, an operation unit 204, a display 206, a load device 208, and a communication unit 210.

The sensor unit 202 may include various types of sensors for sensing various states and situations occurring in an external surrounding environment, an internal system, a user control, and a boarding space of the vehicle 200 (e.g., cameras, LiDAR, radar, ultrasonic sensors, or IMUs, etc.).

Specifically, the sensor unit 202 may include an externally oriented camera 202a, a radar sensor 202b, and the like so as to recognize dynamic and static objects existing around the vehicle 200 (e.g., pedestrians, bicycles, other vehicles, or roadside objects, etc.).

The camera 202a may recognize an external object as an image during use of the vehicle 200 to generate image data and transmit the image data to the processor 218. The image sensor 102a may be mounted on a specific site of the vehicle 200, for example, a front site, a rear site, or a side site of the vehicle 202 (e.g., bumper, windshield, or mirror housings, etc.). When a plurality of image sensors 202a are mounted on each site, it may be referred to as a multi-camera in the present disclosure. The image data obtained by the plurality of image sensors 102a may be called multi-view image data or multi-view (e.g., 360° surround view, stereo view, or fisheye coverage, etc.).

The LiDAR sensor 202b may emit light around the vehicle 200 to generate LiDAR sensor data, for example, a point cloud, through light reflected from an external object in order to determine the type, location, size, heading angle, and the like of the external object (e.g., cars, guardrails, trees, or road signs, etc.). In the present disclosure, it is illustrated that a LiDAR sensor (not shown) is not mounted, but in other examples, the LiDAR sensor may be mounted on the vehicle 200 (e.g., roof-mounted LiDAR, bumper-integrated LiDAR, or corner LiDAR, etc.).

The sensor unit 202 may include a pose sensor 202c. The pose sensor 202c may detect, for example, states of three axes of the vehicle 200, such as yaw, pitch, and roll, and output various pose states of the vehicle based on the above-described factors. The pose sensor may include, for example, an IMU sensor, a gyro sensor, and the like. The processor 218 may generate pose data based on the pose state (e.g., drift-corrected attitude, stabilized heading, or filtered motion state, etc.).

In addition, the sensor unit 202 may include a positioning sensor 202d for confirming the position of the vehicle 200. The positioning sensor 202d is, for example, but not limited to, a GPS sensor or a GNSS sensor (e.g., GPS-L1, Galileo-E1, or GLONASS signals, etc.).

The present disclosure mainly describes the sensors of the sensor unit 202 referred to in the description and may further include sensors that sense various situations not listed therein (e.g., cabin sensors, driver monitoring sensors, or rain/light sensors, etc.).

The operation unit 204 may be configured as a module for a user to steer for driving. For example, the operation unit 204 may be a steering wheel for manual driving, an automatic or manual transmission actuator, an accelerator pedal, a brake pedal, a gear transmission, or the like (e.g., joystick steering, shift-by-wire, or pedal-by-wire, etc.). The operation unit 204 may further include an interface for using, releasing, and selecting a detailed function of an autonomous driving mode requested by the user, such that the user uses the autonomous driving function (e.g., auto-pilot button, cruise-control selector, or lane-keeping switch, etc.).

The display 206 may function as a user interface. The display 206 may be displayed by the processor 218 to output a control state, a control state, route/traffic information, remaining energy information, content requested by the driver, and the like of the vehicle 200 (e.g., navigation, warnings, or infotainment, etc.). In addition, the display 206 may be configured as a touch screen capable of detecting a driver input, to receive a request from the driver instructing the processor 218 (e.g., pinch-zoom, swipe commands, or soft buttons, etc.).

The load device 210 is mounted on the vehicle 200 and may be a type of non-driving electric device excluding a driving power system such as a wheel driving unit (not shown). The load device 114 is an auxiliary device that receives power from the power source unit 212, and may be, for example, an air conditioning system, an indicator lamp system, a lighting system, a seat system, and various devices installed in the vehicle 200 (e.g., heated seats, infotainment units, or ventilation systems, etc.).

The communication unit 210 may support mutual communication with the server 100, the ITS device 300, the surrounding vehicle 400, and the like. The communication unit 210, for example, may include a module that processes cellular communication, WAVE, DSRC communication, and the like (e.g., 5G modem, DSRC transceiver, or WiFi chipset, etc.). In the present disclosure, the communication unit 210 may transmit data generated or stored during driving to the server 100 and receive data and a software module transmitted from the server 100. The communication unit 210 may support communication for transmitting or receiving signals related to data, control, instructions, and requests between the components in FIG. 12. The components may be devices or modules referred to as reference numerals 202 to 218 illustrated in FIG. 12. The communication unit 210 may transmit signals transmitted between the components, that is, signals related to the data, the control, the instructions, and the requests, to a communication bus by using Controller Area Network (CAN) communication, for example, and transmit the signals to a specific component (e.g., sensor fusion ECU, brake ECU, or steering ECU, etc.). The data, the control, the instructions, and the requests transmitted in the CAN communication may be referred to as CAN data. The communication unit 210 may also support communication with an electronic device carried by an occupant inside the vehicle 200 (e.g., smartphone pairing, Bluetooth media, or app-based vehicle control, etc.).

The vehicle 200 may also include a power source unit 212 and an actuator 214.

The power source unit 212 may generate and supply power and electric power to be used for a driving power system and a non-driving power system, such as the actuator 214. The non-driving power system may be, for example, the sensor unit 202, the operation unit 204, the display 206, the load device 208, the communication unit 210, and the like, and is not limited thereto, and may include various components implementing sensing, interface, communication, and convenience functions except for components directly involved in a driving operation (e.g., HVAC, infotainment, or lighting, etc.).

The actuator 214 includes at least one module that implements a driving operation and may execute the driving operation based on a user request from the operation unit 204 or a signal according to a request of the processor 218 (e.g., automated braking, steering, or gear shifting, etc.). The signal according to the request may be related to, for example, at least one of a longitudinal control such as acceleration and deceleration, a lateral control such as steering, and a gear shift. Here, the gear shift may be processed by a request of a manual driving user using a gear transmission or the processor 218 in autonomous driving.

The actuator 214 may include a wheel driving unit (not shown), a mechanical component for implementing a driving operation on the wheel driving unit, and an electronic module to perform a driving operation according to an instruction of the processor 218 by a user's manual control or autonomous driving (e.g., throttle actuator, brake actuator, or steer-by-wire unit, etc.). When the vehicle 200 is operated based on electric energy, the actuator 214 may also include an assembly for transmitting a requested driving operation to the wheel driving unit. When the vehicle 200 is operated based on fossil energy, the actuator may include a transmission and a gear module for transmitting power of an internal combustion engine (e.g., CVT, dual-clutch transmission, or torque converter automatic, etc.).

The wheel driving unit may include a plurality of wheels, a driving force generation module for generating a driving force and applying or transmitting the driving force to the wheels, a braking module for decelerating driving of the wheels, and a steering module for realizing lateral control of the wheels (e.g., ABS unit, ESC unit, or electric power steering, etc.). When the vehicle 200 is driven based on electric energy, the driving force generation module may be configured as a motor assembly that generates a driving force based on electric power output from an electric battery (e.g., front motor, rear motor, or dual-motor AWD, etc.). The braking module of the electric-based vehicle 200 may further have a regenerative braking function.

The vehicle 200 may also include a memory 216 and a processor 218.

The memory 216 may store an application for controlling the vehicle 200 and various data and load the application or read and write the data at the request of the processor 218. The memory 216, for example, may receive and manage a learning model from the server 100 (e.g., model updates, calibration files, or diagnostic data, etc.). As another example, the memory 216 may store an application for removing a ghost object from object detection information based on LiDAR sensor data. In addition, the memory 216 may receive and manage information necessary for driving, such as map information, traffic information, weather information, incident information, and the like (e.g., HD maps, real-time traffic feeds, or hazard alerts, etc.).

The processor 218 may perform overall control of the vehicle 200. The processor 218 may be configured to execute an application and an instruction stored in the memory 216. The processor 218 may use a learning model to detect objects from the sensor data to recognize the objects based on the sensor data (e.g., object detection, lane detection, or scene segmentation, etc.). The processor 218 may autonomously control driving based on the recognized objects. In another example, the processor 218 may use the learning model to generate object detection information based on the LiDAR sensor data and remove ghost objects from the object detection information by the process of FIG. 2. The processor 218 may autonomously control the driving based on the object detection information from which the ghost objects have been removed (e.g., safe braking, path planning, or collision avoidance, etc.).

In the present disclosure, as an example, the processor 218 may be implemented as a single processing module. As another example, the processing according to the foregoing may be distributed in a plurality of processing modules, and the processor 218 may also be collectively referred to as a plurality of processing modules in the present disclosure (e.g., perception ECU, planning ECU, or control ECU, etc.).

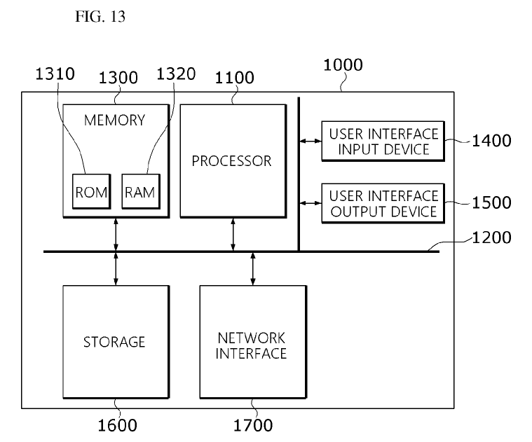

FIG. 13 shows an example computing system (e.g., a computing device of a vehicle or any other apparatus). One or more controllers, processors, etc. described herein, such as one or more components of the vehicle 200, one or more components of the server 100, one or more components of other vehicle 400, and any other components and devices disclosed herein, may be implemented by or in the computing system as shown in FIG. 13.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a method for removing a ghost object, the method comprising: generating allowable point distribution data based on an allowable point distribution estimated from a point distribution assignable to an object associated with a boundary region based on LiDAR sensor data; determining whether the object in the boundary region is a ghost object based on the allowable point distribution data and actual point distribution data of the boundary region; and removing the object determined to be the ghost object.

For examples, the allowable point distribution may be generated based on region allowable distribution data of the boundary region, a region area of the boundary region, and point occupancy data associated with the object. The region allowable distribution data may comprise a point distribution assignable to at least a portion of the boundary region according to specification information of the LiDAR sensor, the region area may be an area of a regional face set based on a relative position between the boundary region and the LiDAR sensor, and the point occupancy data may comprise an occupancy area estimated from a point distribution assignable to the object according to set information.

For examples, the generation of the allowable point distribution data may comprise: generating boundary attribute data based on the region allowable distribution data of the boundary region and the region area of the boundary region; generating point occupancy data including a point occupancy area of the virtual object in the boundary region based on a virtual point assigned according to set information on a virtual object that is associated with the object and is placed in the boundary region; and generating the allowable point distribution data based on the boundary attribute data and the point occupancy data. The region allowable distribution data may comprise a point distribution assignable to at least a part of the boundary region according to specification information of LiDAR sensor, and the region area is an area of a regional face set based on a relative position between the boundary region and the LiDAR sensor.

For examples, the specification information may comprise a resolution of the LiDAR sensor, and the region allowable distribution data may be generated based on the point distribution assignable to the regional face according to the resolution.

For examples, wherein the regional face may be a face defined by a first direction line and a second direction line, the first direction line may be provided to connect vertices associated with extension lines forming a maximum angle among angles between the extension lines connected to the LiDAR sensor for each vertex arranged on a designated face of the boundary region. The second direction line may be provided as a line of the boundary region that extends in a direction different from the designated face and is arranged at the shortest distance from the LiDAR sensor among lines of the boundary region having a vertex arranged on the designated face.

For examples, the boundary attribute data may be generated using a boundary region that is non-occluded by another boundary region of another object, and the non-occluded boundary region is identified based on at least a portion of the LiDAR sensor data of the boundary region not existing in the other boundary region.

For examples, the generation of the point occupancy data may comprise: identifying a maximum height point and a minimum height point among the virtual points for each of a plurality of sections arranged at equal intervals on the virtual object; generating a section area for each section based on a section height matching the maximum height point and the minimum height point; and generating point occupancy data including the occupancy area generated based on the section area for each section.

For examples, the point occupancy data may be generated based on the virtual point assigned on the virtual objects arranged on the regional face.

For examples, the virtual object may be adjusted to conform to the boundary region and is placed in the boundary region, and the set information may comprise the resolution of the LiDAR sensor.

For examples, the method may further comprise controlling driving of a device equipped with the LiDAR sensor that acquires the LiDAR sensor data, based on object detection information from which the object determined to be a ghost object has been removed.

According to another example of the present disclosure, there is provided a device for removing a ghost object, the device comprising: a memory storing at least one instruction; and at least one processor executing the at least one instruction stored in the memory. The at least one processor is configured to: generate allowable point distribution data based on an allowable point distribution estimated from a point distribution assignable to an object associated with a boundary region, based on LiDAR sensor data; determine whether the object in the boundary region is a ghost object based on the allowable point distribution data and actual point distribution data of the boundary region; and remove the object determined to be the ghost object.

According to the present disclosure, it is possible to provide a method and device for removing a ghost object that removes a ghost object caused by unique characteristics of a sensor, thereby improving performance of object detection.

The effects that may be obtained in the present disclosure are not limited to those mentioned above, and other effects not mentioned will be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, the method comprising:
obtaining, via a light detection and ranging (LiDAR) sensor of the vehicle, LiDAR sensor data associated with an environment of the vehicle;
estimating, based on the LiDAR sensor data, an allowable point distribution from a point distribution assignable to an object associated with a boundary region;
generating, based on the allowable point distribution, allowable point distribution data;
determining, based on the allowable point distribution data and actual point distribution data of the boundary region, whether the object is a ghost object;
removing, based on a determination that the object is the ghost object, the object;
outputting a signal indicating the removal of the object; and
controlling, based on the signal, an operation of the vehicle.

2. The method of claim 1,
wherein the allowable point distribution is generated based on:
region allowable distribution data of the boundary region,
a region area of the boundary region, and
point occupancy data associated with the object, and
wherein:
the region allowable distribution data comprises a point distribution assignable to at least a portion of the boundary region based on specification information of the LiDAR sensor,
the region area is an area of a regional face that is set based on a relative position between the boundary region and the LiDAR sensor, and
the point occupancy data comprises an occupancy area estimated from the point distribution assignable to the object.

3. The method of claim 2, wherein the generating of the allowable point distribution data comprises:
generating, based on the region allowable distribution data and the region area, boundary attribute data;
generating the point occupancy data, wherein:
the point occupancy data comprises a point occupancy area of a virtual object placed in the boundary region, and
the point occupancy area is defined based on virtual points, wherein the virtual points are assigned, based on set information associated with the object, to the virtual object; and
generating, based on the boundary attribute data and the point occupancy data, the allowable point distribution data.

4. The method of claim 2,
wherein the specification information comprises a resolution of the LiDAR sensor, and
wherein the region allowable distribution data is generated based on:
a point distribution assignable to the regional face, and
the resolution.

5. The method of claim 3, wherein the regional face is a face defined by a first line and a second line,
wherein the first line connects vertices associated with extension lines that form, for each vertex arranged on a designated face of the boundary region, a maximum angle among angles between the extension lines, wherein the extension lines extend from the vertices toward the LiDAR sensor, and
wherein the second line is a line of the boundary region that extends in a direction different from the designated face and is positioned at a shortest distance from the LiDAR sensor among a plurality of lines of the boundary region, wherein the plurality of lines comprises a vertex arranged on the designated face.

6. The method of claim 5, wherein the allowable point distribution corresponds to an expected point count associated with the boundary region, and
wherein the allowable point distribution data corresponds to an adjusted expected point count obtained by adjusting the expected point count based on a virtual point count of a virtual object positioned within the boundary region.

7. A vehicle comprising:
a sensor configured to provide sensor data associated with an environment of the vehicle;
a driving control circuit configured to control autonomous driving of the vehicle; and
a processor circuit configured to cause the vehicle to:
generate, based on the sensor data, a boundary region corresponding to an object,
determine, based on the sensor data, an actual point count associated with the boundary region,
determine, based on a resolution of the sensor, an expected point count associated with the boundary region,
determine, for the boundary region, a virtual point count defined by a virtual object placed in the boundary region,
adjust, based on the virtual point count, the expected point count,
compare the actual point count to the adjusted expected point count,
determine, based on the comparison, that the object is a ghost object,
remove the boundary region based on the determination that the object is the ghost object,
output a signal indicating the removal of the boundary region, and
control, via the driving control circuit and based on the signal, autonomous driving of the vehicle.

8. The vehicle of claim 7, wherein the processor circuit is further configured to scale a size of the virtual object placed in the boundary region.

9. The vehicle of claim 7, wherein the processor circuit is further configured to align an orientation of the virtual object placed in the boundary region with a heading direction associated with the object.

10. The vehicle of claim 7, wherein the processor circuit is further configured to determine the adjusted expected point count using a ratio between the virtual point count and the expected point count.

11. An apparatus of a vehicle, the apparatus comprising:
a light detection and ranging (LiDAR) sensor configured to obtain LiDAR sensor data associated with an environment of the vehicle;
a processor; and
a memory storing at least one instruction that, when executed by the processor, is configured to cause the apparatus to:
estimate, based on the LiDAR sensor data, an allowable point distribution from a point distribution assignable to an object associated with a boundary region,
generate, based on the allowable point distribution, allowable point distribution data,
determine, based on the allowable point distribution data and actual point distribution data of the boundary region, whether the object is a ghost object,
remove, based on a determination that the object is the ghost object, the object,
output a signal indicating the removal of the object, and
control, based on the signal, an operation of the vehicle.

12. The apparatus of claim 11, wherein the allowable point distribution is generated based on:
region allowable distribution data of the boundary region,
a region area of the boundary region, and
point occupancy data associated with the object, and
wherein:
the region allowable distribution data comprises a point distribution assignable to at least a portion of the boundary region based on specification information of the LiDAR sensor,
the region area is an area of a regional face that is set based on a relative position between the boundary region and the LiDAR sensor, and
the point occupancy data comprises an occupancy area estimated from the point distribution assignable to the object.

13. The apparatus of claim 12, wherein the at least one instruction, when executed by the processor, is configured to cause the apparatus to:
generate, based on the region allowable distribution data and the region area, boundary attribute data,
generate the point occupancy data, wherein:
the point occupancy data comprises a point occupancy area of a virtual object placed in the boundary region, and
the point occupancy area is defined based on virtual points, wherein the virtual points are assigned, based on set information associated with the object, to the virtual object, and
generate, based on the boundary attribute data and the point occupancy data, the allowable point distribution data.

14. The apparatus of claim 12, wherein the specification information comprises a resolution of the LiDAR sensor, and wherein the region allowable distribution data is generated based on:
a point distribution assignable to the regional face, and
the resolution.

15. The apparatus of claim 13, wherein the regional face is a face defined by a first line and a second line,
wherein the first line connects vertices associated with extension lines that form, for each vertex arranged on a designated face of the boundary region, a maximum angle among angles between the extension lines, wherein the extension lines extend from the vertices toward the LiDAR sensor, and
wherein the second line is a line of the boundary region that extends in a direction different from the designated face and is positioned at a shortest distance from the LiDAR sensor among a plurality of lines of the boundary region, wherein the plurality of lines comprises a vertex arranged on the designated face.

16. The apparatus of claim 15,
wherein the boundary attribute data is generated using a portion of the boundary region,
wherein the portion is not occluded by another boundary region of another object,
wherein the portion is identified based on at least a portion of the LiDAR sensor data associated with the boundary region, and
wherein the at least the portion is not included in LiDAR sensor data associated with the other boundary region.

17. The apparatus of claim 13, wherein the at least one instruction, when executed by the processor, is configured to cause the apparatus to:
identify, for each section of a plurality of sections arranged at equal intervals on the virtual object, a maximum height point and a minimum height point among virtual points corresponding to the section,
generate, based on the maximum height point and the minimum height point, a section area for each section of the plurality of sections; and
generate, based on the section areas of the plurality of sections, point occupancy data comprising an occupancy area.

18. The apparatus of claim 11, wherein the allowable point distribution corresponds to an expected point count associated with the boundary region, and
wherein the allowable point distribution data corresponds to an adjusted expected point count obtained by adjusting the expected point count based on a virtual point count of a virtual object positioned within the boundary region.

19. The apparatus of claim 13, wherein the virtual object is adjusted to conform to the boundary region, and wherein the set information comprises a resolution of the LiDAR sensor.

20. The apparatus of claim 11, wherein the at least one instruction, when executed by the processor, is configured to cause the apparatus to control driving of the vehicle based on object detection information from which the ghost object has been removed.
